(19) United States
(12) Patent Application Publication
(10) Pub. No.: US 2024/0327137 A1
(43) Pub. Date: Oct. 3, 2024

(54) CART WITH TILTABLE PLATFORM

(71) Applicant: Aquabot Ltd., Afula (IL)

(72) Inventors: David Shlomo GABRIELI, Ramat Yishai (IL); Yigal Natan RINGART, Givat Ela (IL)

(73) Assignee: Aquabot Ltd., Afula (IL)

(21) Appl. No.: 18/580,605

(22) PCT Filed: Jul. 26, 2022
(86) PCT No.: PCT/IL2022/050810

§ 371 Date: Jan. 18, 2024

Related U.S. Application Data
(60) Provisional application No. 63/225,576, filed on Jul. 26, 2021.

(51) Int. Cl. B65G 47/96

(52) U.S. Cl. CPC B65G 47/962; B65G 47/967

(57) ABSTRACT

A cart includes a chassis that is configured to travel over a track from a loading point to an unloading point; a swivel base supported by the chassis, configured to rotate substantially horizontally in a clockwise direction or an anti-clockwise direction; a tillable platform for carrying an item from the loading point to the unloading point; and a tilt mechanism mounted over the swivel base and configured to tilt the tillable platform between a loading position to an unloading position.

### FIELD OF THE INVENTION

The present invention relates to transport of items. More particularly, the present invention relates to a cart with a tiltable platform for transporting an item (or several items) over a track and unloading the item at a designated location on either sides of the track.

### BACKGROUND OF THE INVENTION

In sorting systems, order fulfillment systems, and other types of delivery systems, various types of goods and items are transported from one location to another. For example, in a sorting system, an item may be transported from a source location, e.g., a loading dock where items are received from a sender, to one of several destination locations, e.g., unloading docks from which items are transported toward different delivery destinations. In an order fulfillment system, ordered items may be transported from a location where that item is stocked (e.g., in a store or warehouse) to a location (e.g., a loading dock) from which ordered items are delivered to the customer who placed the order.

Various transport mechanisms may be utilized in such a delivery system. Examples of transport mechanisms include conveyor belts, conveyor baskets that are suspended from overhead tracks, self- or externally-propelled carts that are confined (e.g., mechanically, electromagnetically, or otherwise) to travel along fixed tracks (e.g., consisting or rails, grooves, channels or tunnels, waterways, guide wires, or other guiding structure), self-propelled vehicles, or other transport mechanism.

### SUMMARY OF THE INVENTION

There is provided, in accordance with some embodiments of the present invention, a cart that includes a chassis that is configured to travel over a track from a loading point to an unloading point; a swivel base supported by the chassis, configured to rotate in a clockwise direction and an anti-clockwise direction; a tiltable platform for carrying an item from the loading point to the unloading point; and a tilt mechanism mounted over the swivel base and configured to tilt the tiltable platform between a loading position to an unloading slanted position.

According to some embodiments of the present invention, the swivel base comprises at least one shaft configured to interact with a guiding arm so as to rotate the swivel base and the tiltable platform to in a desired angle of rotation.

According to some embodiments of the present invention, the at least one shaft comprises two substantially opposite shafts, located opposite each other along an axis substantially orthogonal to the track when the platform is aligned with the track.

According to some embodiments of the present invention, the tilt mechanism comprises a resilient piston that is connected between the swivel base and the tiltable platform, the piston forcibly changeable from an released configuration when the platform is in the unloading position to a cocked configuration, when the platform is in the loading position, the platform; and a restraining mechanism that is configured to maintain the platform in the loading position, and that is releasable to enable a restoring force that is exerted by the piston to tilt the platform from the loading position to the unloading position.

According to some embodiments of the present invention, the restraining mechanism comprises at least one latch.

According to some embodiments of the present invention, the cart further includes at least one trigger arm that is operable to retract said at least one latch from engaging a latch bar.

According to some embodiments of the present invention, the platform comprises side walls and wherein at least one of the side walls is a flipping side wall.

According to some embodiments of the present invention, there is provided a sorting system that includes a track on which at least cart is configured to travel, the cart comprising a chassis that is configured to travel over a track from a loading point to an unloading point; a swivel base supported by the chassis, configured to rotate in a clockwise direction and an anti-clockwise direction; a tiltable platform for carrying an item from the loading point to the unloading point; and a tilt mechanism mounted over the swivel base and configured to tilt the tiltable platform between a loading position to an unloading slanted position, wherein the swivel base comprises at least one shaft; and at least one first guiding arm, configured to be moved between a raised position so as to allow interaction between the at least one shaft and the at least one guiding arm in order to rotate the swivel base in a first desired angle of rotation, and a lowered position, so as to avoid such interaction.

According to some embodiments of the present invention, the system further includes at least one second guiding arm, configured to be moved between a raised position so as to allow interaction between the at least one shaft and the at least one second guiding arm in order to rotate the swivel base in a second desired angle of rotation which is opposite to the first desired angle of rotation, and a lowered position, so as to avoid such interaction.

According to some embodiments of the present invention, said at least one first guiding arm and said at least one second guiding arm are positioned on either sides of the track.

According to some embodiments of the present invention, the at least one shaft comprises two substantially opposite shafts, located opposite each other along an axis substantially orthogonal to the track when the platform is aligned with the track.

According to some embodiments of the present invention, said at least one first guiding arm defines a twisted, confined guiding path between by two opposite openings and between opposite side walls.

According to some embodiments of the present invention, the system further includes a controller to control the at least one cart and the at least one first guiding arm.

According to some embodiments of the present invention, the further includes a sorting gate to identify the item on the platform and a destination of the item.

According to some embodiments of the present invention, the system is provided with a plurality of destination bins located on either sides of the track.

According to some embodiments of the present invention, there is provided a cocking device for a cart with a tiltable platform. The device includes a slanted surface over a track on which the cart is to travel and configured to cock a piston of a tilt mechanism of the tiltable platform by forcing the tiltable platform to regain a substantially horizontal position when passing the slanted surface.

According to some embodiments of the present invention, the device is further provided with a driver for forcefully driving the cart when passing the slanted surface.

According to some embodiments of the present invention, the driver comprises a drive belt tensioned between two wheels and is powered by a motor.

According to some embodiments of the present invention, the drive belt is provided with a plurality of driver protrusions configured to interact with the cart and force the cart to successfully pass the slanted surface.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a cart with a tiltable platform, in accordance with some embodiments of the invention, traveling on a track with the platform aligned in the direction of travel.

FIG. 2 illustrates the cart of FIG. 1, with the tiltable platform in the midst of rotating sideway.

FIG. 3 is a side view of a cart with a tiltable platform, in accordance with some embodiments of the invention, without the tiltable platform and the tilt mechanism.

FIG. 4 is a frontal view of a cart with a tiltable platform, in accordance with some embodiments of the invention, without the tiltable platform and the tilt mechanism.

FIG. 5 illustrates the cart of FIG. 1, with the tiltable platform rotated and tilted to unload an item into a destination bin.

FIG. 6 illustrates the cart of FIG. 1, with the tiltable platform rotated and tilted to unload an item into a destination bin, just before the platform starts rotating back to align with the direction of travel.

FIG. 7 illustrates the cart of FIG. 1, with the tiltable platform rotated and tilted to unload an item into a destination bin, just before the platform starts rotating back to align with the direction of travel, showing parts of the tilt mechanism.

FIG. 8 illustrates the cart of FIG. 1, with the tiltable platform tilted and in the midst of rotating back to an aligned position with respect to the direction of travel.

FIG. 9 illustrates the cart of FIG. 1, with the tiltable platform tilted and aligned with respect to the direction of travel.

FIG. 10 illustrates the cart of FIG. 1, with the tiltable platform in a horizontal position and aligned with respect to the direction of travel.

FIG. 11 is a side view of a cocking device, in accordance with some embodiments of the invention, for forcing a tilted platform to level horizontally, cocking the piston of a tiltable platform of a cart with a tiltable platform back to an energized position.

FIG. 12 is a schematic top view of a sorting system, with a cart with tiltable platform according to some embodiments of the present invention, shown in various stages of operation on the track of the sorting system.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

In accordance with an embodiment of the invention, a cart includes a platform that is tiltable between a horizontal loading orientation in which items may be loaded onto the platform at a loading point and an unloading slanted orientation. The loading orientation is selected so as to prevent or impede the objects that are placed on the platform from falling off of the platform when the cart is still or moving. The cart may then be transported by a transporter mechanism with the item or items that were loaded onto the platform to an unloading point where the items are to be unloaded from the platform. When the cart is at or close to the unloading point, a triggering mechanism may be activated (e.g., by a mechanism that is located at or close to the unloading point), to release a restraining mechanism that is constraining the platform to remain in the loading orientation. As are result of releasing the restraining mechanism, a restoring force that is exerted by a resilient piston mechanism may apply a torque to the platform to tilt the platform (e.g., from the horizontal) to a tilted unloading orientation.

The platform may include a single rotation axis around which the platform may rotate, between a horizontal position and a slanted position.

The piston mechanism may include a compressible gas piston, a compressible or stretchable spring, a coil that may be tightened or wound, a pair of separable mutually attracting magnets, or compressible mutually repelling magnets (e.g., confined to linear motion by an elongated tube, cage, guide wire, or otherwise), or another resilient component that may be forced out of an equilibrium state. Any such resilient component is herein referred to as a piston. For example, one end of the piston may be attached to the platform or to a structure that is attached to the platform, while the opposite end is attached to the chassis of the cart (e.g., a fixed, non-rotatable component of the cart), or to a component that is attached to the chassis. In some cases, one or both of the connections of the ends of the piston to the platform or chassis may be hinged or pivoted to enable relative rotation between the piston and the component to which that end is connected. The rotation may enable or facilitate continued compression or elongation of the piston as the length of the piston changes. Alternatively or in addition, one or both ends of the piston may be configured to push against the platform or chassis (e.g., confined to an indentation or otherwise constrained to prevent dislocation of the piston) without being attached.

The piston may be subjected to a force to energize it and held cocked using a latch or other kind of restraining mechanism. When the restraining mechanism releases its restraining force, the resulting stored potential energy may be released to restore the piston to its released configuration. The resulting restoring force may then apply a torque to the platform to tilt the platform to the unloading orientation.

The restraining mechanism is configured to provide a counterforce to the restoring force of the piston to prevent the piston mechanism from tilting the platform to the unloading orientation until the cart is transported to the unloading point (or when the items are otherwise to be unloaded from the cart). For example, the restraining mechanism may include a mechanical latch that is mounted on the cart (e.g., on a chassis of the cart) that is configured to engage the cooperating structure of the platform or piston mechanism so as to counter the restoring force that is exerted by the piston. Alternatively or in addition, the restraining mechanism may include a mechanical latch that is mounted on the platform or piston mechanism and that is configured to engage cooperating structure that is mounted on the cart (e.g., the chassis). The cooperating structure may include a pin, bar, ring, notch, or other projecting or indented structure that may be engaged by a latch. As another example, the restraining mechanism may include a pin or other projection that is insertable into an indentation on a rotatable component of the restraining mechanism, so as to prevent rotation of that component. As another example, the restraining mechanism may include an electromagnet or another restraining mechanism.

The restraining mechanism includes, or cooperates with, a triggering mechanism that may be operated to release the restraining mechanism. When the restraining mechanism is released, a restoring force that is exerted by the piston mechanism may tilt the platform to the unloading orientation. For example, when the restraining mechanism includes a mechanical latch or pin, the triggering mechanism may include an arm, lever, knob, gear, or other component that when operated (e.g., rotated or displaced) disengages the latch or pin from cooperating structure or indentation. When the restraining mechanism includes multiple latches or pins, a direction of rotation of the rotating component may determine which of the latches is disengaged, thus determining the direction of tilt of the platform.

When the platform is tilted to the unloading orientation, the items may slide off the platform under the force of gravity, or the unloading orientation may otherwise facilitate the removal of the items from the platform (e.g., by a pushing or pulling force that is weaker than the force that would be required to unload the items when the platform is in the loading orientation). For example, the items may slide into a chute, bin, box basket, sack, or other container, or onto another platform or vehicle, for further transport to a destination.

In some cases, e.g., when the piston is a gas piston, the piston may be adjustable (e.g., by adjusting a size of an aperture that enables passage of gas, e.g., air, between the interior of the piston and the ambient atmosphere) so as to limit the applied restoring force or rate of application of the restoring force to a desired force or rate. In other examples, the piston mechanism may include a damping mechanism (e.g., a pneumatic, hydraulic, friction, electromagnetic, or other type of damper) to limit the rate at which the platform is tilted from the loading orientation to the unloading orientation. For example, the adjustable piston or damper may be adjusted to prevent jarring of fragile items that are loaded onto the platform. The piston or damper may be adjusted for a particular type of load.

In some cases, one or more of the restraining mechanism or the piston mechanism may be configured to tilt the platform to one or more orientations that are intermediate between the loading orientation and the unloading orientation. For example, such and intermediate orientation may enable display of an item that is supported by the platform, or access to the item, e.g., for the purpose of marking, inspecting, or otherwise handling or interacting with the item.

A transporter mechanism for transporting the cart from one location to another may include a magnetic propulsion mechanism ( ) For example, the magnetic propulsion mechanism may include a magnet that is drawn along a track to drag the cart along the track or within the track. Alternatively or in addition, the cart may include a self-propulsion mechanism (e.g., an electrically or otherwise powered motor, a transmission mechanism, and wheels, or another type of self-propulsion mechanism), may be towed or otherwise externally propelled (e.g., by connection to a cable, water current, air current, or otherwise that is typically confined to a fixed route), or may be otherwise propelled. For example, the cart may include wheels, runners, glides, or other structure to facilitate transport of the cart over a channel, surface, rail, cable, or other type of surface or guide structure.

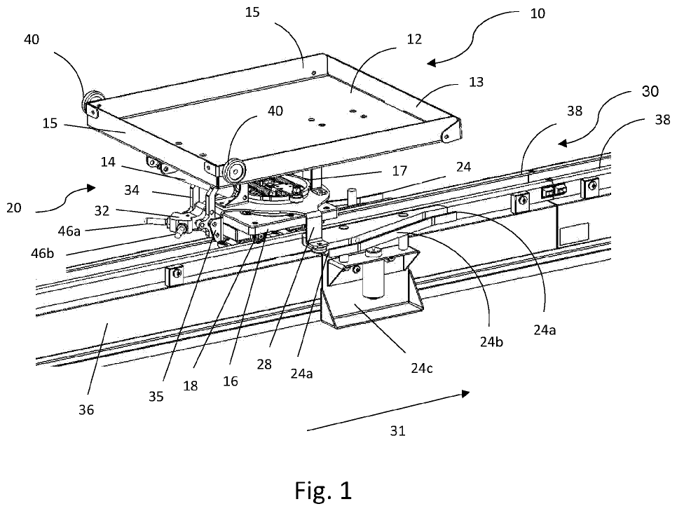

FIG. 1 schematically illustrates a cart with a tiltable platform, in accordance with some embodiments of the invention, traveling on a track with the platform aligned in the direction of travel.

Cart 10 may include a tiltable platform 12. Platform 12 may be configured to support one or more items for transportation and may include side walls 15 to prevent inadvertent sliding and consequent loss of the supported item, and a flipping side wall 13, which may flip when the platform is tilted in the direction of that wall, so as to allow the supported item to slide off the platform.

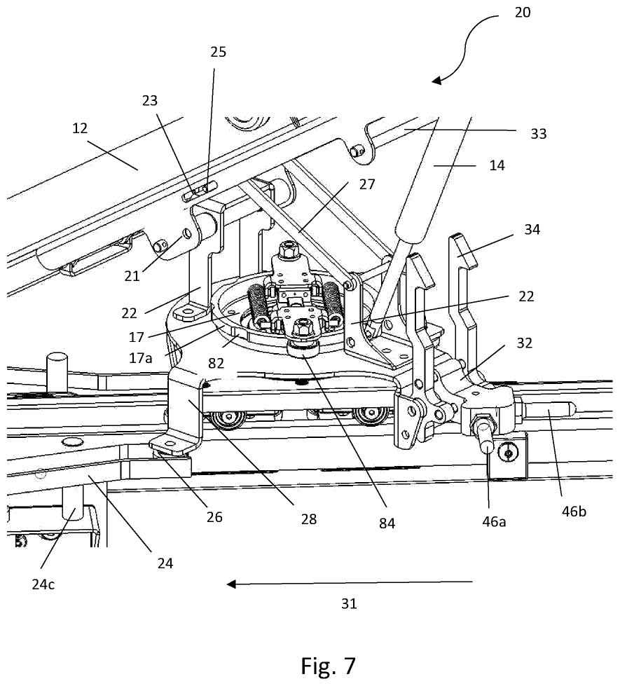

Platform 12 is supported by a tilt mechanism 20 configured to allow changing the position of the platform between horizontal position to a tilted position and vice versa (see also FIG. 7 showing the tilt mechanism in greater detail).

Cart 10 includes unidirectional tilt mechanism 20 that is configured to tilt tiltable platform 12 in a single direction. When tiltable platform 12 is tilted, the platform with the flipping side wall 13 is lowered. Thus, one or more sides of tiltable platform 12 that are not in the direction of the tilt may include a fixed side walls 15. Side walls 15 may prevent or impede items from falling off a side of tiltable platform 12.

In the example shown, tiltable platform 12 is oriented in a loading orientation that is substantially horizontal. When tiltable platform 12 is in the loading orientation, latch bar 33 (see FIG. 7) fixed beneath platform 12 is held in place by one or more latches 34. Latches 34 are located at an end of latch arm 32, which is fixed to carrier chassis 16. When tiltable platform 12 is in the loading orientation, piston 14 is compressed from its equilibrium configuration. The compressed piston 14 exerts a pushing force which is countered by the restraining force that is exerted on latch bar 33 by latches 34.

Trigger arms 46a and 46b are, separately or integrally, connected to latches 34 via latch arm 32. In the example shown, when any of the trigger arms 46a or 46b is hit (e.g., by a side actuator), latch arm 32 rotates and release latches 34 from latch bar 33. With latches 40 removed from latch bar 33, the pushing force of piston 14 on platform 12 is no longer countered. The pushing force of the released piston exerts a torque to rotate tiltable platform 12 rotates platform 12 such that the end with the flipping side wall 13 is lowered. Tiltable platform 12 is thus tilted to the unloading orientation, facilitating unloading of items from tiltable platform 12 over flipping side wall 13.

In the example shown, piston 14 is in the form of a gas piston that is compressed when tiltable platform 12 is in the loading orientation. In other examples, piston 14 may include another type of compressible (or stretchable) resilient element.

Cart 10 is configured to be propelled along a track 30. For example, cart 10 may be provided with a self-propulsion mechanism (e.g., electrical motor and transmission) that propels horizontal wheels 18a (see, for example, FIG. 4), e.g., functioning as drive wheels, to roll along track 30, supported on wheels 18. Horizontal wheels 18a are configured to rotate horizontally about a vertical axis, to generate a propelling force when in contact with a vertical or sloped surface (rails 38). In other examples, drive wheels may be otherwise oriented, e.g., vertically to rotate about a horizontal axis, or with an intermediate slope. In other examples, drive wheels may be arranged in row with, or may be identical with, wheels 18.

Alternatively or in addition, a propulsion mechanism may be external to cart 10. For example, the propulsion mechanism may include a fixed magnet or permanent magnets 29 attached to the bottom of the cart 10 that is configured to be pulled along by magnetic fields created by electrical coils embedded in track base 36 of track 30, or involve magnets 29 (see FIG. 4) that interact with a magnetic propulsion system. In order to crate a fixed pulling force for the cart 10 a constant gap between the bottom face of the permanent magnets 29 and the top face of the track 30 is maintained by the wheels 18. In another example, the propulsion mechanism may be configured to attach to or grab a cable or belt that moves within or next to track 30, between two parallel track rails 38. In such an example, horizontal wheels 18a may be free spinning, e.g., to provide lateral stability when traveling along carrier track 30.

Support columns 22 (see FIG. 7) may be provided, configured to hold tiltable platform 12 at a predetermined height above track 70. For example, the height of tiltable platform 12 may be selected to provide sufficient clearance between tiltable platform 12 in one or more orientations and a platform or other structure that is located alongside track 30.

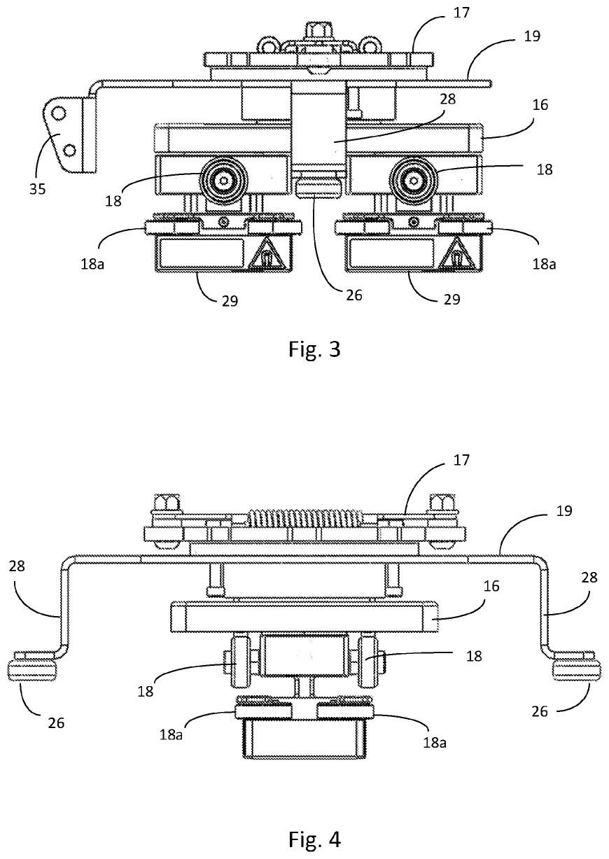

FIG. 3 is a side view of a cart with a tiltable platform, in accordance with some embodiments of the invention, without the tiltable platform and the tilt mechanism.

FIG. 4 is a frontal view of a cart with a tiltable platform, in accordance with some embodiments of the invention, without the tiltable platform and the tilt mechanism.

Support columns 22 (see FIG. 7) that support the tiltable platform 12 and the tilt mechanism 20 are mounted over swivel base 19. (see FIG. 7) which is coupled by a crossed roller bearing 17 to chassis 16, thus allowing swivel base 19 along with tiltable platform 12 and tilt mechanism 20 is allowed to rotate horizontally about an axis that is substantially orthogonal to track 30. The rotation of swivel base 19 is designed to allow horizontal rotation of the tiltable platform, so as to allow directing the unloading of items off the platform into a chute, bin, basket, sack, or other container, or onto another platform or vehicle, for further transport to a destination (hereinafter referred to as “unloading point” for brevity), which may be located on either or both sides of the track 30. Swivel base 19 is provided with two substantially opposite shafts 28, which are located opposite each other along an axis substantially orthogonal to the track, when cart 10 travels over track 30. A substantially horizontal wheel 26 may be coupled to each shaft 28, for example, at the bottom of that shaft.

Cart 10 may travel over track 30, and meet with raisable guiding shafts 24, located alongside track 30. Guiding shaft 24 is configured to be moved, between a raised position, by a displacer 24c, to interact with the facing shaft 28 of swivel base 19, to a lowered position to allow that shaft to pass uninterrupted over that guiding arm and vice versa. Guiding arm may be provided on either sides of track 30 or on both sides, depending on the relative position of the unloading point with respect to the track (e.g., on the right hand side or the left hand side, or both). Guiding arm 24 defines a confined, twisted, guiding path defined between two opposite openings 24a (entrance and exit) and between substantially opposite side walls 24b so as to receive horizontal wheel 26 of shaft 28, and guide it in the guiding path either forcing the horizontal wheel 26 (and shaft 28) to draw closer to or further from track 30. When shaft 28 interacts with a raised guiding arm swivel base 19 is forced to rotate horizontally clockwise or anti-clockwise, depending on the design of the guiding arm and its position (left or right, with respect to the direction of travel 31 of the cart 10) with respect to the track 30. The angle of rotation may be predetermined, according to various operation and/or design considerations. According to some embodiments of the present invention, the angle of rotation (e.g., with respect to the direction of travel) may be preset to an angle in the range of 20-60 degrees, e.g., 45 degrees. Other rotation angles may be selected, of course, depending on system requirements. The swivel base may be configured to snap into a desired angle position, for example, by having dents 82 on the perimeter of a flange 17a of the swivel base around the crossed roller bearing 17, and a restraining wheel 84 that snaps into the appropriate dent 82 and holds the swivel base in the desired position until a force is applied to rotate the swivel base away from that angle.

By planning the positions of the guiding arms it is possible to manipulate platform 12, which is mounted over swivel base 19, in order to facilitate unloading to the right or to the left of the track (with respect to the direction of travel 31 of the cart), to successfully unload an item in a desired unloading direction.

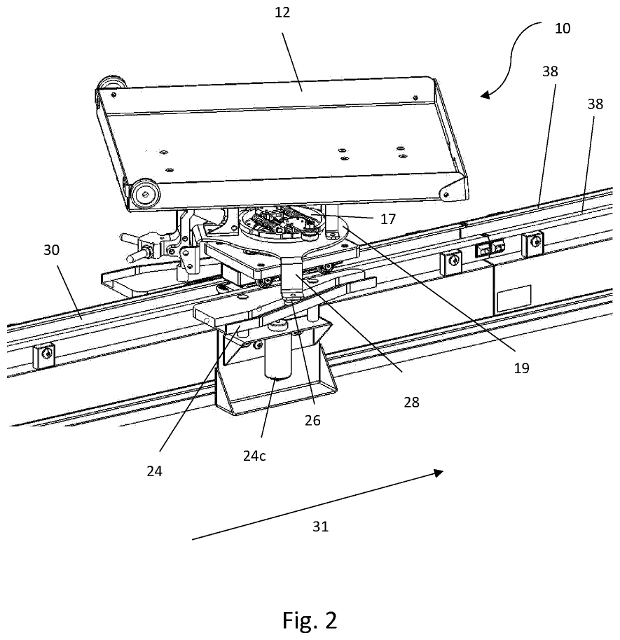

FIG. 2 illustrates the cart of FIG. 1, with the tiltable platform in the midst of rotating sideway. Guiding arm 24 on the right hand side of the track (with respect to the direction of travel 31) was raised by the displacer 24c as to interact with horizontal wheel 26 of shaft 28, while a corresponding guiding arm 24 on the left hand side of track 30 is maintained in the lowered position avoiding interaction with the opposite shaft. As the guiding arm defined path forces shaft 28 to draw closer to track 30 this causes swivel base 19 to rotate clockwise (to the right).

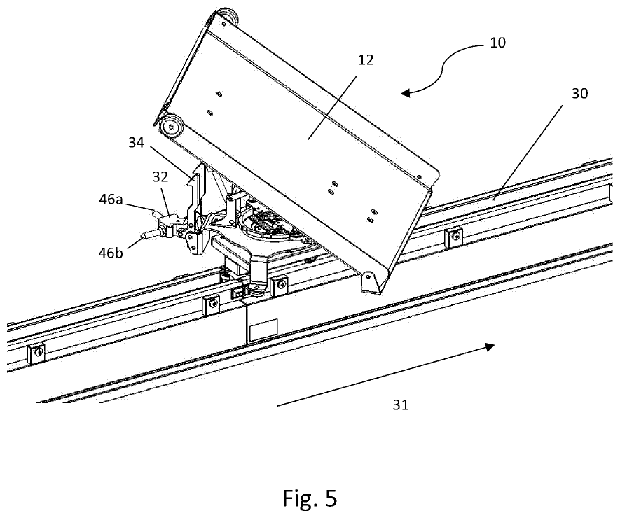

FIG. 5 illustrates the cart of FIG. 1, with the tiltable platform rotated and tilted to unload an item into a destination bin. When trigger arm 46a is actuated (e.g., by a designated actuator at the unloading point, not shown for brevity), the tilt mechanism is operated causing the tilting of platform 12, and consequent unloading of an item that was on the platform 12 into a receptacle at the unloading point.

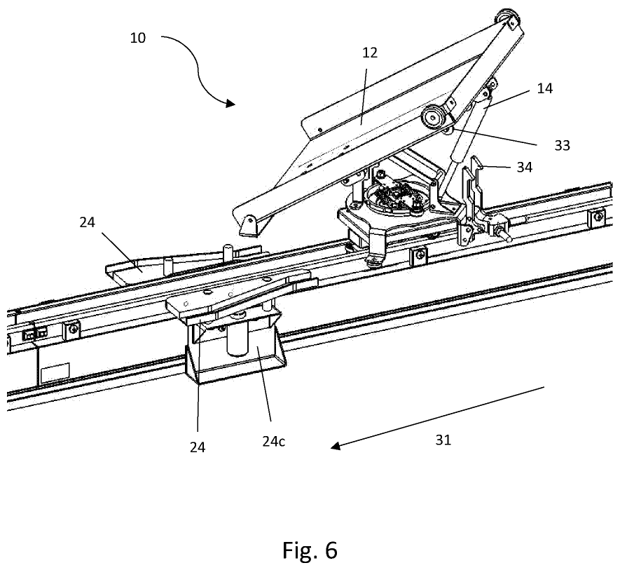

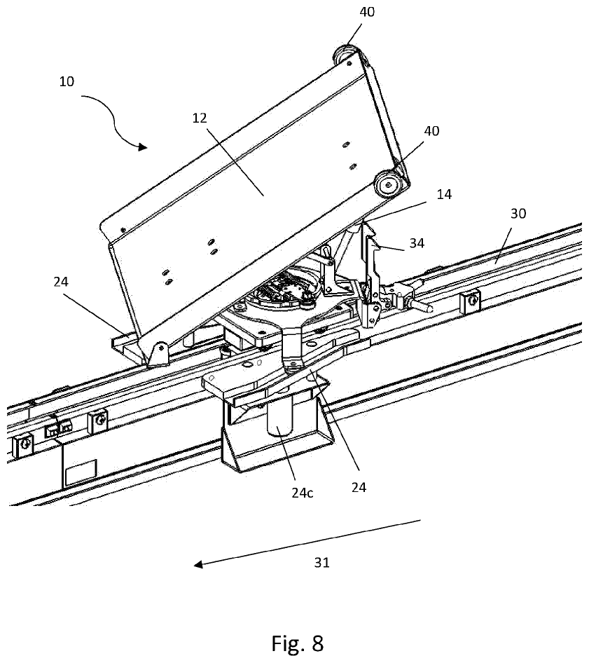

FIG. 6, FIG. 7 and FIG. 8 illustrate the cart of FIG. 1, with the tiltable platform rotated and tilted to unload an item into a destination bin, just before the platform starts rotating back to align with the direction of travel (FIG. 6), during the rotation (FIG. 7) and completing the rotation (FIG. 8). At an exit from an unloading point a guiding arm may be provided, such that when the unloading has completed, and the cart 10 moves on guiding arm 24 may be raised to interact with shaft 28 and cause swivel base 19 to rotate anti-clockwise to realign platform 12 with the direction of travel of the cart.

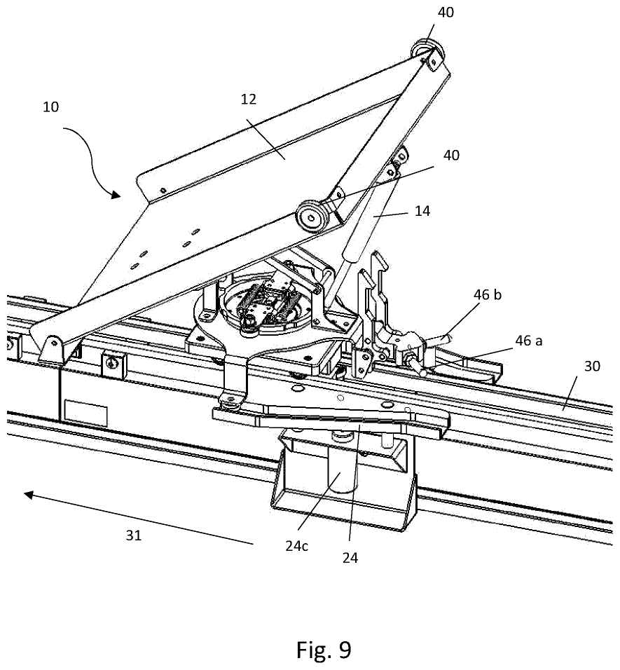

FIG. 9 illustrates the cart of FIG. 1, with the tiltable platform tilted and aligned with respect to the direction of travel.

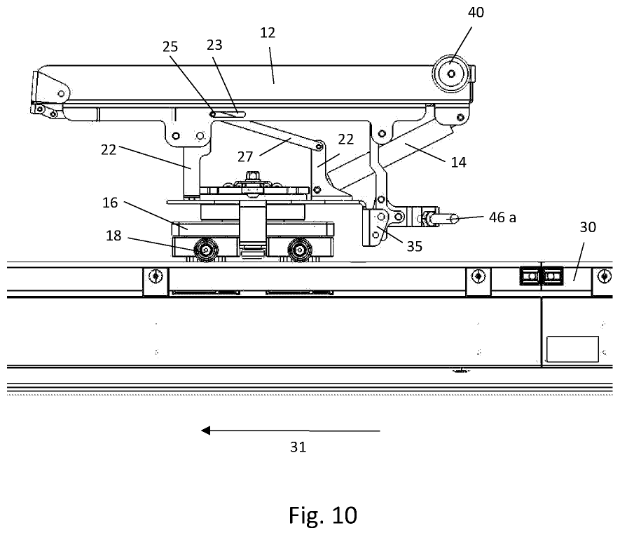

FIG. 10 illustrates the cart of FIG. 1, with the tiltable platform in a horizontal position and aligned with respect to the direction of travel. The platform may be returned to its horizontal position by cocking piston 14 of tilt mechanism 20 of cart 10.

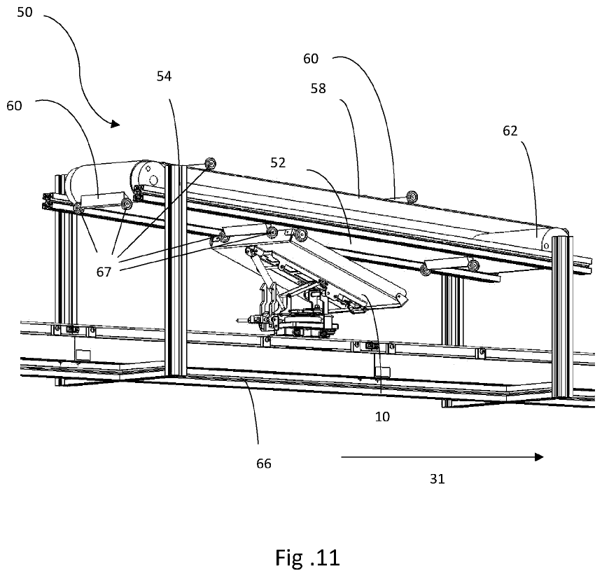

FIG. 11 is a side view of a cocking device 50, in accordance with some embodiments of the invention, for forcing a tilted platform to level horizontally, cocking the piston of a tiltable platform of a cart with a tiltable platform back to an energized position. Cocking device 50 may include cocking surface 52, for example a slanted rigid bar, or other type of slanted surface, e.g., the down facing inclined surface of a drive belt or a chain 58 held in its inclined position by two support columns 54 mounted onto support bar 66. Cocking surface 52 is configured to restrain the movement of cart 10 by providing a tapered space between the track 30 and the cocking surface 52 as cart 10 advances underneath the driver belt 58. Cocking wheel 40 may be provided on the side (or both sides) of platform 12 so as to aide with the advancing of the cart under the drive belt 58. Cocking surface 52 applies a force on platform 12 forcing platform 12 to realign horizontally while energizing piston 14, resetting the cart for the next delivery.

Cart 10 may successfully pass under cocking surface 52 using own (or track's) propulsion. Alternatively, or additionally, it may be prudent to provide a driver 56 to force cart 10 to move under cocking surface 52 and energize piston 14. Driver 56 may include a drive belt 58 that is tensioned between two belt wheels 62, and provided with driver protrusions 60 protruding from drive belt 58, and driven by motor 64. When driver belt is operated, driver protrusions 60 move with drive belt 58, and may interact with the top of platform 12 (e.g., side wall 15) and push it forward to force the cart to successfully pass underneath the slanted cocking surface 52.

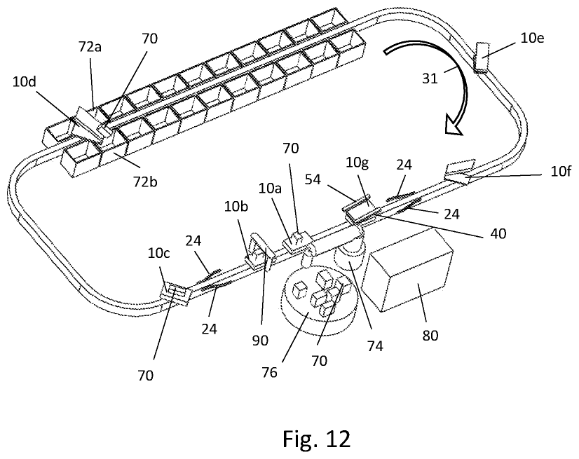

FIG. 12 is a schematic top view of a sorting system, with a cart with tiltable platform according to some embodiments of the present invention, shown in various stages of operation on the track of the sorting system.

Cart 10 is shown at different operation positions when traveling over track 30 of a sorting system. Cart 10a is at a loading point, where a picking device 74 loads an item 70 for transportation to a designated bin. Item 70 may be selected from batch of items in a box 76 of items for delivery in platform 12. Cart 10 advances over track 30 to position 10b, where it passes at (e.g., under) sorting gate 90, which may include an optical sensor or other kind of sensor configured to identify the item and its destination bin. Once the destination bin is determined controller 80 can command the proper guiding arm 24 to be raised so as to cause platform 12 of cart 10 to rotate in the correct direction (left or right, depending on the known location of the destination bin). Cart 10c has its platform rotated in the proper direction as it travels further along track 30 in the direction of the destination bins. When cart 10d arrives to or close to the unloading point, an actuator is used to actuate the trigger of the cart and cause the tilt mechanism to operate and tilt platform 12 to its unloading tilted position, dropping item 70 into bin 72b. After dispensing item 70 cart 10e proceeds to travel along track 30 swinging back (10f). Just before arriving at cocking device 50, another set of guiding arms 24 is provided, which may be operated by controller 80 to turn the rotated platform back to a position aligned with track 30. Upon arriving at cocking device 50, platform 12 of cart 10 g is forced to regain its horizontally aligned position, cocking piston 14, where it may then proceed to the loading point for a new item to be loaded onto platform 12 and delivered to the appropriate destination bin.

Different embodiments are disclosed herein. Features of certain embodiments may be combined with features of other embodiments; thus certain embodiments may be combinations of features of multiple embodiments. In particular, the various tilting, restraining, propulsion, door opening, and other mechanisms that were described in connection with either a bidirectional tilt mechanism or a unidirectional tilt mechanism, may be used with the other mechanism, either directly applied or adapted to the other mechanism in a manner that is known in the art.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Hereinafter is an index of elements appearing in the appended figures:
10—cart;
10a—cart at loading location;
10b—cart at sorter gate;
10c—cart turned to predetermined unloading direction;
10d—cart at unloading site;
10e, 10f—cart returning to loading location;
10g—cart passing at the cocking device;
12—tiltable platform;
13—flipping side wall;
14—piston;
15—fixed side wall;
16—cart chassis;
17—crossed roller bearings;
17a—flange;
18—wheels;
18a—horizontal wheels;
19—swivel base;
20—tilt mechanism;
21—hinge;
22—support columns;
23—slit;
24—guiding arm;
24a—opening;
24b—side rail;
24c—displacer;
25—slider pin;
26—shaft wheel;
27—tilt bar;
28—side shaft;
29—magnet;
30—track;
31—direction of travel;
32—latch arm;
34—latch;
35—latch holder;
36—track base;
38—track rail;
40—cocking wheel;
46a, 46b—trigger arm;
50—cocking device;
52—cocking surface;
54—support columns;
56—driver;
58—drive belt;
60—driver protrusion;
62—belt wheel;
64—motor;
66—support bar;
70—item for delivery;
72a. 72b—destination bins;
74—picking device;
76—box of items for delivery;
80—controller;
82—dent;
84—restraining wheel;
90—gate.

1. A cart comprising:
a chassis that is configured to travel over a track from a loading point to an unloading point;
a swivel base supported by the chassis, configured to rotate in a clockwise direction and an anti-clockwise direction
a tiltable platform for carrying an item from the loading point to the unloading point; and
a tilt mechanism mounted over the swivel base and configured to tilt the tiltable platform between a loading position to an unloading slanted position.

2. The cart of claim 1, wherein the swivel base comprises at least one shaft configured to interact with a guiding arm so as to rotate the swivel base and the tiltable platform to a desired angle of rotation.

3. The cart of claim 2, wherein the at least one shaft comprises two substantially opposite shafts, located opposite each other along an axis substantially orthogonal to the track when the platform is aligned with the track.

4. The cart of claim 1, wherein the tilt mechanism comprises a resilient piston that is connected between the swivel base and the tiltable platform, the piston forcibly changeable from a released configuration when the platform is in the unloading position to a cocked configuration, when the platform is in the loading orientation position; and
a restraining mechanism that is configured to maintain the platform in the loading position, and that is releasable to enable a restoring force that is exerted by the piston to tilt the platform from the loading position to the unloading position.

5. The cart of claim 4, wherein the restraining mechanism comprises at least one latch.

6. The cart of claim 5, further comprising at least one trigger arm that is operable to retract said at least one latch from engaging a latch bar.

7. The cart of claim 1, wherein the platform comprises side walls and wherein at least one of the side walls is a flipping side wall.

8. A sorting system comprising:
a track on which at least one cart is configured to travel, the cart comprising a chassis that is configured to travel over a track from a loading point to an unloading point; a swivel base supported by the chassis, configured to rotate in a clockwise direction and an anti-clockwise direction; a tiltable platform for carrying an item from the loading point to the unloading point; and a tilt mechanism mounted over the swivel base and configured to tilt the tiltable platform between a loading position to an unloading slanted position, wherein the swivel base comprises at least one shaft; and
at least one first guiding arm, configured to be moved between a raised position so as to allow interaction between the at least one shaft and the at least one guiding arm in order to rotate the swivel base in a first desired angle of rotation, and a lowered position, so as to avoid such interaction.

9. The sorting system of claim 8, further comprising at least one second guiding arm, configured to be moved between a raised position so as to allow interaction between the at least one shaft and the at least one second guiding arm in order to rotate the swivel base in a second desired angle of rotation which is opposite to the first desired angle of rotation, and a lowered position, so as to avoid such interaction.

10. The system of claim 9, wherein said at least one first guiding arm and said at least one second guiding arm are positioned on either sides of the track.

11. The system of claim 8, wherein the at least one shaft comprises two substantially opposite shafts, located opposite each other along an axis substantially orthogonal to the track when the platform is aligned with the track.

12. The system of claim 8, wherein said at least one first guiding arm defines a twisted, confined guiding path between by two opposite openings and between opposite side walls.

13. The system of claim 8, further comprising a controller to control the at least one cart and the at least one first guiding arm.

14. The system of claim 8, further comprising a sorting gate to identify the item on the platform and a destination of the item.

15. The system of claim 8, provided with a plurality of destination bins located on either sides of the track.

16. A cocking device for a cart with a tiltable platform, the device comprising
a slanted surface over a track on which the cart is to travel and configured to cock a piston of a tilt mechanism of the tiltable platform by forcing the tiltable platform to regain a substantially horizontal position when passing the slanted surface.

17. The device of claim 16, further provided with a driver for forcefully driving the cart when passing the slanted surface.

18. The device of claim 17, wherein the driver comprises a drive belt tensioned between two wheels and powered by a motor.

19. The device of claim 18, wherein the drive belt is provided with a plurality of driver protrusions configured to interact with the cart and force the cart to successfully pass the slanted surface.
